(19) United States
(12) Patent Application Publication
(10) Pub. No.: US 2009/0173660 A1
(43) Pub. Date: Jul. 9, 2009

(54) CARRIER TAPE WITH EXCELLENT IMPACT STRENGTH AND RELEASE PROPERTY

(76) Inventors: Jun Seok Lee, Seoul (KR); Dong-Soo Lee, Seoul (KR); Wan-Goo Kim, Seoul (KR)

Correspondence Address: 3M INNOVATIVE PROPERTIES COMPANY, PO BOX 33427, ST. PAUL, MN, 55133-3427, US

(21) Appl. No.: 12/281,261

(22) PCT Filed: Mar. 9, 2007
(86) PCT No.: PCT/US2007/006087

§ 371 Date: Oct. 16, 2008

(30) Foreign Application Priority Data
Mar. 17, 2006 (KR) 10 2006 0024876

(51) Int. Cl. B65D 85/00; B29C 47/00

(52) U.S. Cl. 206/713; 264/176.1

(57) ABSTRACT

Disclosed is a carrier tape manufactured by using polymer materials comprising polypropylene, polystyrene and a styrene-butadiene copolymer. The carrier tape has excellent impact strength, excellent dimensional stability and low surface energy, and thus allows easy detachment of materials to be transported.

### TECHNICAL FIELD

The present invention relates to a carrier tape, which has excellent impact strength and dimensional stability, and allows easy detachment of materials to be transported, due to its low surface energy.

### BACKGROUND ART

In general, a carrier tape means a tape that serves to transport electronic components to a circuit or a substrate in order to mount the electronic components on the circuit or substrate. More particularly, carrier tapes function to transport electronic components, such as a resistor, a capacitor, an inductor, a conductor, or the like, to a desired position in an automated assembly equipment. Herein, in each processing step for the assembly, a component transported by a carrier tape is separated from the carrier tape, and then is used for the assembly. The carrier tape used as described above is a strip-like structure comprising a series of concave portions (pocket portions) for receiving materials to be transported, which are spaced apart from each other by a uniform distance, wherein the pocket portions are formed in such a manner that electronic components are closely adhered thereto and received therein.

Additionally, in order to drive the strip-like structure and to cause the pocket portions to be located in correct positions to the assembly equipment along the carrier tape, openings, which serve as indexes, and holes for transferring the carrier tape are formed on the lateral surface of the carrier tape and spaced apart from each other by a uniform distance.

Generally, a carrier tape is transferred to a desired position by way of the rotation of a reel, on which the holes for transferring the carrier tape are suspended. For example, when a carrier tape is used in a process for assembling an electronic product, electronic components supplied from a component supplier are loaded into the concave portions (pocket portions) for receiving materials to be transported, in the carrier tape. Next, a cover strip is adhered to the pocket portions containing the electronic components in order to fix the components (see FIG. 6a), or an adhesive is applied onto the bottom surface of the pocket portion in order to cause the components to be adhered and fixed on the bottom surface (see FIG. 4). Then, the reel is rotated so as to transfer the components contained in the pocket portions of the carrier tape to desired positions in the assembly equipment. In order to form the concave portions (pocket portions) for receiving materials to be transported or the holes for transferring the carrier tape in such carrier tapes, a thermoforming process or punching process may be performed on the strip material.

Meanwhile, when the materials (electronic components) to be transported by the carrier tape are adhered to the pocket portions for receiving the materials, the components should be separated from the carrier tape before they are used in the assembly equipment. To perform such separation work, the components are generally separated from the adhesive used for adhesion of the components by applying an impact to the bottom of the pocket portions to which the components are attached. However, in this case, such application of an impact may adversely affect the components. For example, the components may be cracked.

In order to facilitate separation of electronic components adhered to the pocket portions, such attempts as using a polymer film with low surface energy to manufacture carrier tapes have been made. For example, polypropylene films have been used to manufacture carrier tape. However, a carrier tape made of a polypropylene film can be problematic in that lateral surfaces of a carrier tape may be wrinkled or bent, and cambers can be generated. As shown in FIGS. 5a and 5b, a camber refers to the non-planarity generated in a planar article. When cambers are generated excessively in a carrier tape, the distance between pocket portions becomes irregular, which cause a problem in the transportation of components. And, such poor dimensional stability results in defects, particularly in the case of a small-sized ca mer tape, thereby inhibiting automation of assembly.

Therefore, there is an imminent need for a carrier tape, which has a stable shape, high impact strength and excellent dimensional stability, and allows easy separation of a material adhered thereto with its low surface energy.

### SUMMARY

Therefore, the present invention has been made in view of the above-mentioned problems. It is an object of at least one embodiment of the present invention to provide a carrier tape, which maintains its shape stably, has high impact strength and excellent dimensional stability, and allows a material adhered thereto to be separated with ease.

It is another object of at least one embodiment of the present invention to provide a carrier tape, which has excellent impact strength so as to transfer a material in a safe and stable manner.

It is still another object of at least one embodiment of the present invention to provide a carrier tape, which has low surface energy, high impact strength and excellent dimensional stability.

According to an aspect of the present invention, there is provided a carrier tape, which has a polymer film shape formed of polymer materials comprising polypropylene (PP), polystyrene (PS) and a styrene-butadiene copolymer, and has pocket portions that are concave portions for receiving materials to be transported, and holes for transferring the carrier tape.

The outline of a carrier tape according to an aspect of the present invention has a polymer strip shape formed of polymer film substrate, and such polymer film may be prepared by blending a copolymer composition, which comprises polypropylene (PP), polystyrene (PS) and a styrene-butadiene copolymer.

According to a preferred embodiment of the present invention, the polymer film comprises about 5˜40 wt % of polypropylene, about 50˜90 wt % of polystyrene and about 5˜40 wt % of a styrene-butadiene copolymer.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a schematic view showing the carrier tape according to a preferred embodiment of the present invention, wherein one hole for transferring the carrier tape is formed per each pocket portion;

FIG. 2A is a schematic view that shows the carrier tape according to another preferred embodiment of the present invention and the dimension of each constitutional element, expressed by a specific parameter, wherein two holes for transferring the carrier tape is formed per each pocket portion;

FIG. 2B is a schematic view showing the pocket portions, which are concave portions for receiving materials to be transported, and the holes for transferring the carrier tape, in the carrier tape as shown in FIG. 2A;

FIG. 3A is a view illustrating the processes of placing materials to be transported a the carrier tape according to a preferred embodiment of the present invention, attaching a cover tape to the carrier tape and winding the tape on a frame;

FIG. 3B is a view illustrating a close-up view of pockets of the carrier tape shown in FIG. 3A containing the materials to be transported;

FIG. 4 is a view illustrating a process for transporting an insulating product by a carrier tape;

FIG. 5A is a view illustrating the concept of a camber, wherein a camber is generally represented by the height of arched surface for a certain length;

FIG. 5B is a view illustrating the acceptable range of a camber in the carrier tape according to the present invention, wherein a camber of 2 mm or less per 250 mm (length) is preferred in the case of level winding, while a camber of 1 mm or less per 250 mm (length) is preferred in the case of planar winding;

FIG. 6 is a schematic view showing a carrier tape according to the prior art; and

FIG. 7 is a schematic view showing the cross-sectional view of another carrier tape according to the prior art.

### DETAILED DESCRIPTION

The carrier tape according to the present invention has pocket portions that are concave portions for receiving materials to be transported, and holes for transferring the carrier tape, wherein the pocket portions and the holes may be arranged at uniform intervals. Such arrangement is advantageous to an automated process.

According to the carrier tape manufactured by using the above polymer tape, it is possible to prevent generation of cracks on the materials to be transported, such as electronic components, when the materials are transported/separated by/from the carrier tape. Also, it is possible to prevent the carrier tape from being bent at its lateral surface and to prevent generation of cambers. Therefore, it is possible to ensure the three-dimensional stability of the carrier tape.

Hereinafter, the present invention will be explained in more detail with regard to the constitutional elements of the polymer film used in the carrier tape.

### Polypropylene (PP)

Generally, propylene is produced along with ethylene from a naphtha cracking process in a petrochemical plant. Meanwhile, polypropylene may be prepared by the polymerization of propylene in the presence of the Ziegler-Natta catalyst. The polypropylene prepared as described above has an isotactic structure, in which methyl groups are aligned in the same direction, and it is essentially composed of carbon atoms and hydrogen atoms. The polypropylene is widely used in packaging films, oriented tapes, fibers, pipes, general goods, toys, industrial components, containers, or the like.

The carrier tape comprising polypropylene has low surface energy, and thus allows electronic components adhered to the pocket portions to be separated with ease. However, such PP-based carrier tapes can be problematic in that they can be wrinkled or bent at the lateral surfaces and cambers are generated. Therefore, the present invention solved the above problems by blending polypropylene with polystyrene and a styrene-butadiene copolymer, and manufacturing a carrier tape by using the blended polymer resin.

According to a preferred embodiment of the present invention, polypropylene is used in an amount of about 5˜40 wt % based on the total weight of the polymer film for the carrier tape.

According to another embodiment of the present invention, polypropylene, which has rubbery characteristics and is prepared by introducing a small amount of ethylene monomers during the polymerization of polypropylene, may be used. As the above polypropylene, block copolymer type or random copolymer type polypropylene having an ethylene content of about 2˜20 wt % may be used.

### Polystyrene (PS)

Polystyrene is colorless and transparent, has low specific gravity, and shows excellent electrical properties. Also, polystyrene has high light stability, and thus is a plastic material that has the strongest resistance against radiation. Polystyrene is softened or dissolved in organic solvents, such as essences, ketones, esters, aromatic hydrocarbons, or the like, while it has excellent resistance against acids, alkalis, salts, mineral oils, organic acids, lower alcohols, or the like. Because polystyrene has excellent thermal stability and flowability when it is dissolved, it has excellent moldability. Particularly, polystyrene is suitable for injection molding, has excellent dimensional stability after molding due to its low shrinkage during a molding process, and is cost-efficient. Although polystyrene has the above-mentioned advantages, it has a relatively low softening temperature and shows insufficient hardness.

According to the present invention, polystyrene having the above-mentioned characteristics is used along with polypropylene to compensate for the disadvantages of both materials and to maximize the advantages of both materials.

In other words, it is possible to solve the problems caused by a polypropylene film according to the prior art, through the combination of the advantages of polypropylene (i.e. low surface energy) with the advantages of polystyrene (i.e. excellent dimensional stability, moldability and thermal stability). That is, by the combination of polypropylene and polystyrene, the problems of using polypropylene alone such as generation of bending in the lateral surface of a polypropylene film and generation of cambers, elliptical bending, in the preparation of a carrier tape may be overcome.

According to a preferred embodiment of the present invention, polystyrene is used in an amount of about 50˜90 wt % (preferably, about 55˜80 wt %) based on the total weight of the polymer film or the carrier tape.

Particular examples of the polystyrene that may be used in the present invention include general purpose polystyrene. In other words, any commercially available polystyrene may be used in the present invention. There are many types of polystyrene resins, and various grades of polystyrene resins are commercially available. Therefore, polystyrene optimized to the particular use may be selected and used. According to another embodiment of the present invention, polystyrene products with a grade for extrusion may be used as the polystyrene.

### Styrene-Butadiene Copolymer

In the polymer film for the carrier tape according to the present invention, the styrene-butadiene copolymer functions as a compatibilizer that increases miscibility between polypropylene and polystyrene, thereby increasing the impact strength. In other words, in a styrene-butadiene copolymer, the styrene moiety is connected to polystyrene and the butadiene moiety is connected to polypropylene, so that the miscibility between polypropylene and polystyrene can be increased.

According to a preferred embodiment of the present invention, the styrene-butadiene copolymer is used in an amount of about 5˜40 wt % based on the total weight of the polymer film for the carrier tape.

Particular examples of the styrene-butadiene copolymer that may be used in the present invention include a styrene-butadiene copolymer, styrene-ethylene-butadiene-styrene copolymer, styrene-butadiene-styrene copolymer, or the like. A preferred example of the styrene-butadiene copolymer that may be used in the present invention has a styrene content of about 5˜60 wt % and a butadiene content of about 40˜95 wt %.

### Polymer Film for Carrier Tape

The polymer film for the carrier tape according to the present invention may be prepared by blending a copolymer composition of polymer materials, comprising about 5˜40 wt % of polypropylene, about 50˜90 wt % of polystyrene and about 5˜40 wt % of a styrene-butadiene copolymer. More particularly, as the styrene-butadiene copolymer, at least one copolymer, selected from the group consisting of a styrene-butadiene copolymer, styrene-ethylene-butadiene-styrene copolymer, and styrene-butadiene-styrene copolymer, may be used.

According to a preferred embodiment of the present invention, the polymer film of the carrier tape has a thickness of about 0.15˜0.30 mm so as to provide a carrier tape.

### Carrier Tape

The carrier tape according to the present invention can be manufactured in a form of polymer film.

In an embodiment of the present invention, the carrier tape can be manufactured by forming pocket portions that are concave portions for receiving materials to be transported and holes for transferring the carrier tape in the polymer film obtained by blending the copolymer composition, which comprises polypropylene (PP), polystyrene (PS) and a styrene-butadiene copolymer. The pocket portions that are concave portions for receiving materials to be transported, and the holes for transferring the carrier tape may be formed by punching the polymer film. In other words, the holes for transferring the carrier film may be formed by punching the polymer film so that the polymer film is perforated. Meanwhile, the concave portions for receiving materials to be transported may be formed by punching the polymer film in such a manner that the polymer film is not perforated but is provided with pocket-shaped concave portions.

In another embodiment of the present invention, the carrier tape can be manufactured by blending the copolymer composition of polymer materials comprising polypropylene (PP), polystyrene (PS) and a styrene-butadiene copolymer, and extruding it while forming pocket portions that are concave portions for receiving materials to be transported and holes for transferring the carrier tape. For example, in the process of extrusion, the blended copolymer composition of polymer materials extruded in a melt film state may be wound on a rounded tool having pocket shapes to form pocket portions that are concave portions for receiving materials to be transported, and after a few seconds (3 to 5 seconds) it may be punched at its lateral side to form holes for transferring the carrier tape. In this case, forming pocket portions and holes for transferring the carrier tape is performed simultaneously with the extrusion of film, the process becomes simple and the productivity can increase.

If desired, the size or interval of the pocket portions that are concave portions for receiving materials to be transported, and the holes for transferring the carrier tape may be controlled by one skilled in the art. According to a preferred embodiment of the present invention, the polymer film of the carrier tape may have a thickness of about 0.15˜0.30 mm. The carrier tape may have a length and width determined optionally by one skilled in the art.

Methods for manufacturing a carrier tape and the punching method are generally known to one skilled in the art. Such methods can be applied to the above polymer film in order to manufacture the carrier tape according to the present invention. The carrier tape according to the present invention may further comprise other constitutional elements in addition to the pocket portions that are concave portions for receiving materials to be transported, and the holes for transferring the carrier tape.

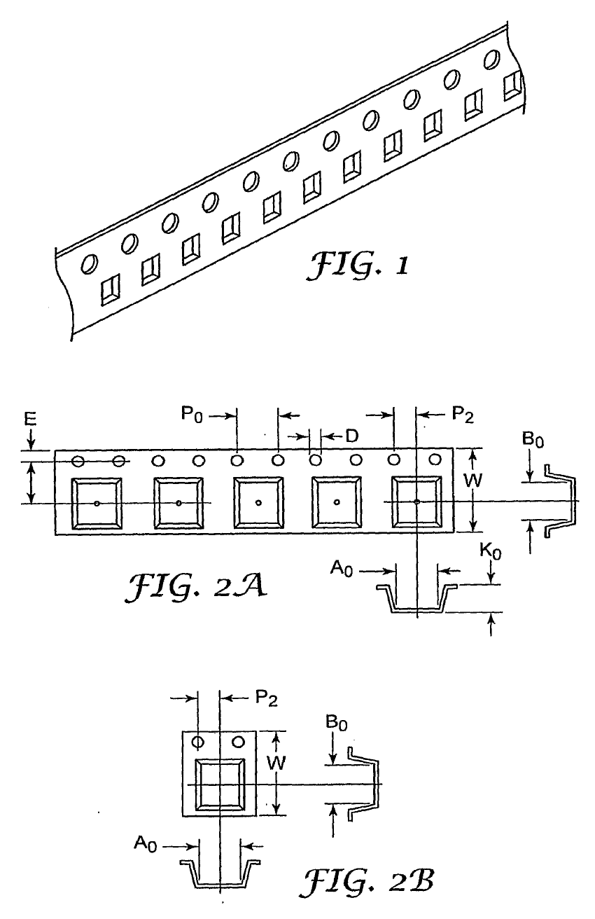

Preferred embodiments of the carrier tape include the carrier tapes as shown in FIGS. 1, 2A and 2B. FIG. 1 is a perspective view of a carrier tape of the present invention. FIGS. 2A and 2B illustrate the dimensions of a carrier tape and individual pocket, respectively, of an embodiment of the present invention. A₀ is the pocket width, B₀ is the pocket length, K₀ is the pocket height, P₀ is the pitch between sprocket holes, P₂ is the pitch between sprocket hole and pocket hole. D is a sprocket hole for transferring, i.e., moving, the carrier tape through a process line. E is the distance between from the carrier tape edge to a sprocket hole center. W is the width of the carrier tape.

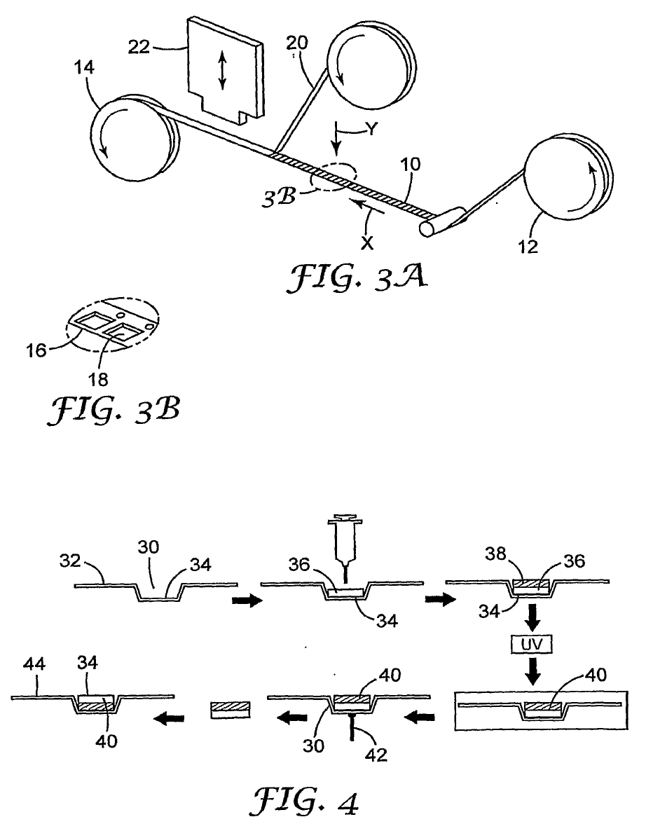

FIGS. 3A and 3B illustrate a process of placing materials to be transported in a carrier tape of the present invention. According to the illustrated process, carrier tape 10 is dispensed from reel 12 in direction X. As carrier tape move toward wind-up reel 14, pockets 16 are filled with material 18 at location Y. Subsequently, cover tape 20 is applied to carrier tape 10 by sealing head 22.

FIG. 4 illustrates a process for using carrier tapes to form and transport an insulated product. Step 1 illustrates a pocket 30 of carrier tape 32 to which a coating 34 has been applied. Step 2 illustrates insulation material 36 being dispensed into pocket 30. Step 3 illustrates device 38 inserted into insulation material 36. Step 4 illustrates the U curing of coating 34/insulation material 36/device 38 to form cured device 40. Step 5 illustrates the bottom of pocket 30 be struck with instrument 42 to dislodge cured device 40. Step 6 illustrates cured device 40 with coating 34 facing upward placed in carrier tape 44 for transportation.

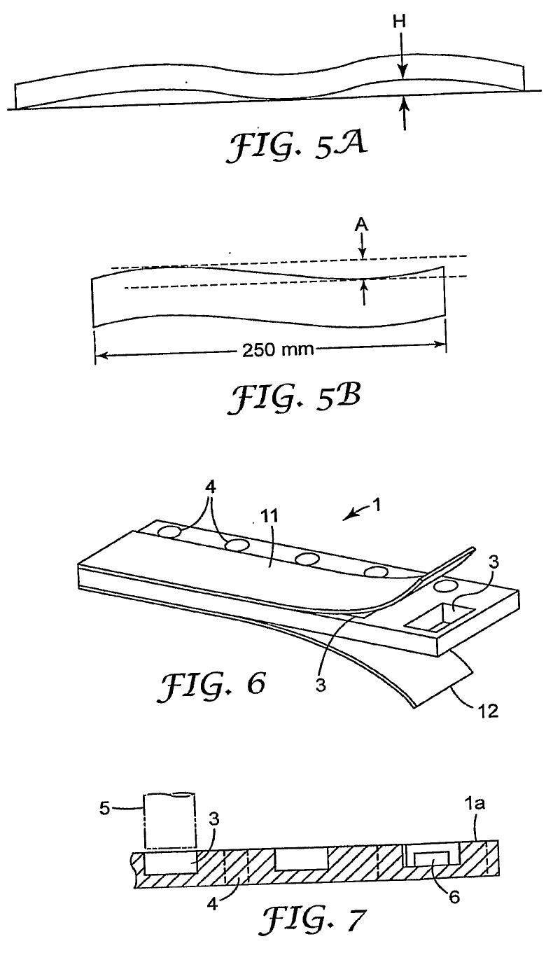

FIG. 5A illustrates the concept of a camber, wherein a camber is generally represented by the height H of arched surface for a certain length. FIG. 5B illustrates a generally acceptable range of a camber A in a carrier tape according to the present invention, wherein a camber of 2 mm or less per 250 mm (length) is preferred in the case of level winding, and a camber of 1 mm or less per 250 mm (length) is preferred in the case of planar winding.

FIG. 6 is a schematic view showing a carrier tape 1 according to the prior art showing pocket portions 3, sprocket holes 4, cover tape 11 and base tape 12.

FIG. 7 is a schematic view showing the cross-sectional view of another carrier tape according to the prior art showing carrier tape substrate 1a, pocket portions 3, sprocket holes 4, punch 5, which is used to form pocket portions 3, and device 6, which is transported in the carrier tape.

Particularly, the carrier tape according to the present invention is useful for transporting electronic components such as coil inductors, coil conductor, or the like. It is a matter of course that the carrier tape may be used to transport other electronic components and assembly units.

The carrier tape according to the present invention has advantages of low surface energy derived from polypropylene, as well as excellent dimensional stability, moldability and thermal stability, derived from polystyrene. In other words, because the carrier tape has low surface energy derived from polypropylene, it is possible to separate the materials transported by the carrier tape easily from the carrier tape. In addition, by the use of polystyrene combined with polypropylene, it is also possible to solve the problems occurring in conventional carrier tapes using polypropylene film alone, such as bending at the lateral surface of the polypropylene film and generation of cambers (see FIGS. 5a and 5b). Therefore, it is possible to ensure precision during the manufacture and transport of the carrier tape.

Further, in the carrier tape according to the present invention, a styrene-butadiene copolymer functions as a compatibilizer, so as to increase the miscibility between polypropylene and polystyrene, and thus to increase the impact strength. Additionally, it is possible to improve the workability of the carrier tape by the blending of the polymer materials.

When a carrier tape is manufactured by using the above polymer materials according to the present invention, it is not necessary to apply an excessive impact to the carrier tape in order to separate the materials transported by the carrier tape. Therefore, it is possible to prevent the material from cracking. Additionally, it is possible to prevent the polymer film for the carrier tape from bending at its lateral surface and from generating cambers. Therefore, it is possible to ensure the three-dimensional stability of the carrier film.

### EXAMPLES

It is to be understood that the following examples are illustrative only and the scope of the present invention is not limited thereto.

### Example 1

A polymer film was manufactured by using the polymer materials as shown in the following Table 1.

TABLE 1

| Materials | Blending Ratio | Type | MI |
|---|---|---|---|
| Polypropylene (PP) | 28% | Block Copolymer | 1.7 |
| Polystyrene (PS) | 66% | GPPS | 3 |
| SEBS | 6% | Compatibilizer | 3.3 |

In Table 1, MI means a melt index.

As the polypropylene, block copolymer type polypropylene, which has rubbery characteristics and is prepared by adding about 7 wt % of ethylene monomers during the polymerization of polypropylene, was used.

As the polystyrene, general purpose polystyrene (GPPS) for extrusion, having a melt index of 3, was used.

As the styrene-butadiene block copolymer, SEBS (styrene-ethylene-butadiene-styrene) copolymer was used.

The polypropylene, polystyrene and SEBS were introduced into a hopper for an extruder for manufacturing a carrier tape, and blended then extruded. In the course of extrusion, the extruded melt polymer was molded by winding it on a rounded tool having pocket shapes, and punched at its lateral side to form holes for transferring the carrier tape. Then, the molded and punched product was wound on a reel to provide a carrier tape, as shown in FIGS. 2a and 2b.

Referring to the parameters as shown in FIGS. 2a and 2b, the equipment for manufacturing the carrier tape was designed in such a manner that the resultant carrier tape has dimensions corresponding to A₀ of 0.86˜0.96 mm, B₀ of 1.51˜1.61 mm, and P₂ of 1.95-2.05 mm. Results for the measurement of each parameter are shown in Table 3.

Meanwhile, a camber was defined as a degree of arched surface for the length of 250 mm. Each pocket was designed to have a depth of 0.86˜0.96 mm.

### Example 2

A polymer film was manufactured by using the polymer materials as shown in the following Table 2 in the same manner as described in Example 1. Then, a carrier tape with the same size as described in Example 1 was manufactured.

TABLE 2

| Materials | Blending Ratio | Type | MI |
|---|---|---|---|
| Polypropylene (PP) | 6% | Block Copolymer | 1.7 |
| Polystyrene (PS) | 57% | GPPS | 3 |
| Styrene-Butadiene | 37% | Block Copolymer | 3.3 |
| Copolymer (SBC) | | | |

As shown in Table 2, SBC (styrene-butadiene copolymer) was used as a styrene-butadiene block copolymer.

### Comparative Example 1

A carrier tape with the same size as described in Example 1 was manufactured by using polypropylene alone.

### Experimental Example 1

### Dimensional Stability

Dimensions and cambers of the carrier tapes according to Examples 1-2 and Comparative Example 1 were measured. The Results are shown in the following Table 3.

TABLE 3

| | A0 (mm) | B0 (mm) | P2 (mm) | Camber (mm) |
|---|---|---|---|---|
| Theoretical range | 0.86~0.96 | 1.51~1.61 | 1.95~2.05 | <1 |
| Comp. Ex. 1 | 0.894 | 1.532 | 1.952 | 0.992 |
| Ex. 1 | 0.914 | 1.557 | 1.997 | 0.213 |
| Ex. 2 | 0.921 | 1.565 | 2.01 | 0.221 |

As can be seen from the results of Table 3, the carrier tape according to the present invention shows excellent dimensional stability, as demonstrated by the measured dimensions approximate to the medians of the theoretical ranges. Additionally, a lower camber value is preferred. The carrier tapes according to the Example 1-2 have a camber value, which is significantly lower compared to Comparative Example 1.

### Experimental Example 2

### Surface Energy and Impact Strength

Surface Energy and Impact Strength of the carrier tapes according to Examples 1-2 and Comparative Example 1 were measured.

Surface Energy was measured according to Dyne solution test (ASTM D-2578, Published August, 2004) and Impact Strength was measured according to Notched izod impact strength (ASTM D256; Published November, 2004) with 0.125 inch sample. The Results are shown in the following Table 4.

TABLE 4

| | Surface Energy | Impact Strength |
|---|---|---|
| | (dynes/cm) | (J/m) |
| Comp. Ex. 1 | 28 | 137 |
| Ex. 1 | 31 | 215 |
| Ex. 2 | 33 | 150 |

As can be seen above, the carrier tape of the present invention has excellent dimensional stability and impact strength. In addition, it has relatively low surface energy, and thus can accomplish excellent dimensional stability and impact strength without noticeable increase of surface energy. Therefore, the carrier tape of the present invention can be used for transporting components in an automated equipment, while not causing operational errors and degradation of processability.

As can be seen from the foregoing, the carrier tape, manufactured by using mixed polymer materials comprising polypropylene (PP), polystyrene (PS) and a styrene-butadiene copolymer according to the present invention, has excellent impact strength and low surface energy, and thus allows the materials transported by the carrier tape to be separated easily with no cracking. Also, it is possible to prevent the carrier tape from bending at its lateral surfaces or from generating cambers, and thus, the carrier tape has excellent dimensional stability and is suitable for a process performed in an automated equipment. Particularly, the carrier tape is useful for transporting components during the assemblage of an electronic product.

While this invention has been described in connection with what is presently considered to be the most practical and preferred embodiment, it is to be understood that the invention is not limited to the disclosed embodiment and the drawings. On the contrary, it is intended to cover various modifications and variations within the spirit and scope of the appended claims.

1. A carrier tape, which has a polymer film shape formed of polymer film materials comprising polypropylene, polystyrene and a styrene-butadiene copolymer, and has pocket portions that are concave portions for receiving materials to be transported, and holes for transferring the carrier tape.

2. The carrier tape according to claim 1, wherein the polymer film is prepared by blending a mixed copolymer composition of polymer materials, which comprises polypropylene, polystyrene and a styrene-butadiene copolymer.

3. The carrier tape according to claim 2, wherein the polymer film comprises about 5 to about 40 wt % of polypropylene, about 50 to about 90 wt % of polystyrene and about 5 to about 40 wt % of a styrene-butadiene copolymer.

4. The carrier tape according to claim 1, wherein the polypropylene comprises about 2 to about 20 wt % of ethylene.

5. The carrier tape according to claim 1, wherein the styrene-butadiene block copolymer is selected from the group consisting of a styrene-butadiene copolymer, a styrene-ethylene-butadiene-styrene copolymer, and a styrene-butadiene-styrene copolymer.

6. A method for manufacturing a carrier tape, which comprises:
blending polymer materials comprising about 5 to about 40 wt % of polypropylene, about 50 to about 90 wt % of polystyrene and about 5 to about 40 wt % of a styrene-butadiene copolymer; and
extruding the blended polymer materials, while forming pocket portions that are concave portions for receiving materials to be transported, and holes for transferring the carrier tape.

7. The method according to claim 6, wherein the styrene-butadiene block copolymer is selected from the group consisting of a styrene-butadiene copolymer, a styrene-ethylene-butadiene-styrene copolymer, and a styrene-butadiene-styrene copolymer.
